(19) United States
(12) Patent Application Publication
(10) Pub. No.: US 2002/0087457 A1
(43) Pub. Date: Jul. 4, 2002

(54) Transaction system

(76) Inventors: Tim Madeley, Dublin (IE); Stephen Wynne, Dublin (IE); Keith Troy, County Kildare (IE); Sean Foley, Dublin (IE)

Correspondence Address: Woodcock Washburn Kurtz, Mackiewicz & Norris LLP, One Liberty Place - 46th Floor, Philadelphia, PA, 19103, US

(21) Appl. No.: 09/866,085

(22) Filed: May 25, 2001

(30) Foreign Application Priority Data
May 25, 2000 (IE) S2000/0412

(51) Int. Cl. G06F 17/60

(52) U.S. Cl. 705/37

(57) ABSTRACT

A system for automatically determining a margin for a transaction comprises at least one margin table in which is stored a plurality of deal factors that specify a requested deal and a margin value associated with the factors. A search engine operates to search the table for an entry that corresponds to a proposed transaction and to calculate a margin value therefrom. Each margin table is included in a margin tier, the tier being adapted to contain a plurality of margin tables. The tables are searched by the search engine in a predetermined order to find a margin for a proposed deal on a “first matched” basis. Additional tiers may be provided to adjust or override a margin value obtained from a preceding tier. Some embodiments of the invention permit a trader to specify a profit amount for a deal to be used as the basis for calculating a rate for a deal.

### BACKGROUND TO THE INVENTION

Field of the Invention

The present invention relates to a transaction system and in particular to a transaction system for automatically determining and applying margins to a transaction such as a financial transaction.

Financial transaction systems typically provide a variety of financial services, including core services such as FX (foreign exchange, providing a client with money in one currency for payment in another currency) and MM (money market, providing a loan to a client or paying interest on money provided by a client).

One task that typically must be carried out by a transaction system is calculation of a client rate, at which the transaction is offered to a customer, from a bank rate, that represents the actual cost of the transaction to the institution offering the service (for example, the rate at which a currency is trading on the open market). For example, the rates may be a conversion rate in an FX transaction or an interest rate in an MM transaction. The rates are most typically calculated by application of a margin to the bank rate. In this context, the margin is defined as the difference between the client rate and the bank rate. The margin may be one of several types, most typically referred to as “pips”, “percentage”, or “amount”. The pips type specifies a number of units of the relevant currency; the percentage type specifies a percentage of the market rate; and the amount type specifies an absolute amount. The pips type may specify which of the two currencies is to be used, most particularly in the case of MM transactions. In most cases, the margin is expressed in pips, and where a percentage margin is specified, it will normally be converted to a pips value before the client rate is calculated.

When calculating a margin for a transaction, various rules are followed of varying degrees of complexity, as is appropriate for the transaction concerned. The complexity should only go as far as to allow a financial institution flexibility while not creating extra training requirements or increasing troubleshooting and support time requirements of the system itself. A wide variety of factors may be taken into account in calculating the appropriate margins to charge for such transactions, such as the type of the transaction (FX or MM), the nature of the particular transaction (e.g. Spot, Forward, or Swap for FX), the client, the client group, the branch, the size of the transaction, and the currency or currencies involved.

In simple systems, the margin may be calculated manually, possibly involving the discretion of the operator. In automated systems, the margin determination procedure must be defined and programmed into the system. In principle, this is required in a real-time automatic quoting environment. However, in practice, it rapidly results in considerable complexity, as more and more distinctions and special situations are catered for. Perhaps more seriously, it makes amendment and updating of the system extremely onerous. Adding new distinctions or criteria to an existing program can be more difficult than writing the program in the first place, and checking that the new distinctions or criteria are consistent with the already existing ones (both as originally programmed and as added by previous amendments) may be even more difficult.

An aim of this invention is provide a system that allows an institution to set up records for calculating a margin for a given transaction that are as simple or complex as required for a particular application, and which allows these records to be readily amended when required.

In typical systems, and in some embodiments of the present invention, the profit or margin obtained by a bank or a financial institution is specified in terms of pips or points. In conducting a transaction, a bank will take a market rate, apply the margin and the profit will then be derived from the rate and the margin that has been applied to the market rate. While this method of calculation is entirely acceptable in many situations, it does have the disadvantage that the dealer does not automatically know the exact amount of profit that will be made on the deal. Although the dealer can calculate an approximate profit and amend the margin to adjust the profit as appropriate, this is a time-consuming operation that can interfere with transactions that are often time critical.

Therefore, another aim of the invention is to provide a system that allows a dealer to specify an amount of profit that is to be made on a specific deal.

### SUMMARY OF THE INVENTION

From a first aspect, the invention provides a transaction system for automatically determining a margin for a transaction comprising: at least one margin table in which is stored a plurality of deal factors that specify a requested deal and a margin value associated with the factors; a search engine for searching the table for an entry to correspond to a proposed transaction, search rules for searching the table and to calculate a margin value therefrom, wherein the margin table is included in a margin tier, the tier being adapted to contain a plurality of margin tables which can be searched by the search engine in a predetermined order.

An administrator can add tables to the tier or delete tables from the tier as requirements to specify transactions in greater or lesser detail changes over time.

In a typical transaction system embodying the invention, the margin is derived from the first margin table entry in the margin tier that is found by the search engine. This allows an administrator to specify more specific deal conditions in an earlier part of the search order of a tier, and more general deal conditions in a later part of the search order of a tier.

The margin tables within a tier may contain a dissimilar number of deal factors. Most typically, each table within a tier contains a number of deal factors not greater than the number of deal factors contained in any preceding table of the tier. This ensures that the deals specified in a tier become generally less specific as the search order of the tier becomes more detailed or specific.

A transaction system embodying the invention may comprise a plurality of margin tiers, each tier containing at least one margin table. In general, the search engine searches each tier in turn to attempt to obtain a margin value from each tier. This permits a margin value obtained from a first tier to be further refined by a value from one or more subsequent tiers. A margin value obtained from a tier other than the first tier may override or adjust a margin value obtained from a previous tier.

In a system according to the last-preceding paragraph, the search engine is typically configured to abandon a search in the event that no match for a transaction is found in the first tier. However, the search engine typically operates to ignore any tier, other than the first tier, in the event that no match for a proposed transaction is found in that tier.

In some instances, there may be more than one possible in a table when a search is carried out for a component of a cross deal. Therefore, in preferred embodiments of transaction system embodying the invention, a margin value in a tier may be associated with a priority value that indicates which of a plurality of alternative margin values should be selected for a particular transaction. Such priority values have particular, but not exclusive, application in selecting between a plurality of alternative margin values to be applied to a cross component of a cross deal.

A transaction system embodying the invention most typically further comprises an administration tool by means of which an administrator can add, amend or delete entries from a margin tier, and add, amend or delete a margin tier. Moreover, the administration tool can preferably add amend or delete deal factors from a margin table. This gives an administrator a great deal of control over the factors taken into account when a margin is calculated.

A system embodying the invention is particularly suited to calculate margins for foreign exchange or money market transactions.

A typical system embodying the invention may further comprise a quotation server operative to generate a price from a transaction based on a calculated margin value. A user interface may also be provided for presenting calculated transaction data to a user.

From another aspect, the invention provides a transaction system, optionally in accordance with an earlier aspect of the invention, in which a dealer can specify an amount of profit to be made on a deal, and the system is operative to calculate a client rate to be applied to a deal to make the required profit in the required currency. Specifically, the invention provides a transaction system operative to calculate a client rate for a deal required to represent profit as pips and thus make a specified profit on the deal.

In this aspect of the invention, an FX or MM transaction typically involves a fixed amount that a customer wishes to transact, a market rate at which the transaction is available to the financial institution concerned, and a fixed profit that the financial institution wishes to make. The last of these values is typically derived from information stored in margin tables in accordance with the first aspect of the invention.

From another aspect the invention provides a method for automatically determining a margin for a transaction comprising storing in a plurality of margin tables a plurality of deal factors that specify a possible deal and a margin value associated with the factors; searching the margin table for an entry corresponding to a proposed transaction; and calculating a margin value therefrom, wherein the margin tables are stored in a margin tier, and are searched in a predetermined order.

Such a method may further comprise a step of calculating a quote for a deal based on the determined margin value. Additionally, the method may further comprise steps of obtaining data specifying a proposed deal from a user, and presenting a calculated quotation for a deal to a user.

In cases where the transaction is an FX cross deal, and a cross component of the transaction may be determined by a step that includes comparison of priority values associated with a plurality of rate values, and the method selects the rate value that has the higher or highest priority. Such a system can enhance the manageability of a system embodying the invention.

A method embodying this aspect of the invention is typically employed by a system embodying the invention.

From another method aspect, the invention provides a method for automatically determining a margin for a transaction optionally in accordance with any other aspect of the invention which calculates a rate for a deal that is required to yield a specified profit on a deal.

In preferred embodiments, such a method calculates a margin A to generate a profit F in the following steps, or mathematical equivalents thereof:

1. D=(C/B)

2. G=(F/B)

3. E=(D+/−G)

4. A=(C/E)

where

B=Market Rate;

C=Fixed Amount of the transaction;

D=Market Counter Amount;

E=Client Counter Amount; and

G=Fixed Profit Counter Amount.

### BRIEF DESCRIPTION OF THE DRAWINGS

An embodiment of the invention will now be described in detail, by way of example, and with reference to the accompanying drawings, in which:

FIG. 1 is a diagrammatic representation of a system embodying the invention;

FIG. 2 is a diagrammatic representation of a region of memory in a system embodying the invention;

FIG. 3 represents a margin tier being a memory structure forming part of the embodiment of FIG. 1;

FIG. 4 is a diagram showing the interrelationship between three margin tiers in the embodiment of FIG. 1;

FIG. 5 is a flow diagram of a first search algorithm executed by the embodiment of FIG. 1;

FIG. 6 is a flow diagram of a second search algorithm executed by the embodiment of FIG. 1;

FIG. 7 shows margin tables referred to in a description of a first group of examples of margin calculation by an embodiment of the invention;

FIG. 8 shows margin tables referred to in a description of a second group of examples of margin calculation by an embodiment of the invention; and

FIG. 9 shows margin tables referred to in a description of a third group of examples of margin calculation by an embodiment of the invention.

### DETAILED DESCRIPTION OF A PREFERRED EMBODIMENT

The procedures undertaken by a system embodying the invention will now be described with reference to an FX transaction. However, it should be understood that such procedures could also be applied to MM transactions. Where there are differences in the procedures that are applied to these two transaction types, such differences will be noted.

Overview of Margins and Associated Concepts

In order for a bank to make a profit in a transaction, it will apply a margin to the market rate to get a client rate. Many factors (so-called “deal factors”) may be taken into account when a margin is calculated. These may, for example, include the branch or branch group of the institution, the particular client or client group, instrument, band, the currency or currencies involved in the transaction, the period over which or in which the transaction is to take place, and the line of business; that is to say, whether the transaction is FX or MM.

A function of this system is to facilitate the creation and administration of relationships between deal factors and margins.

The Preferred Embodiment

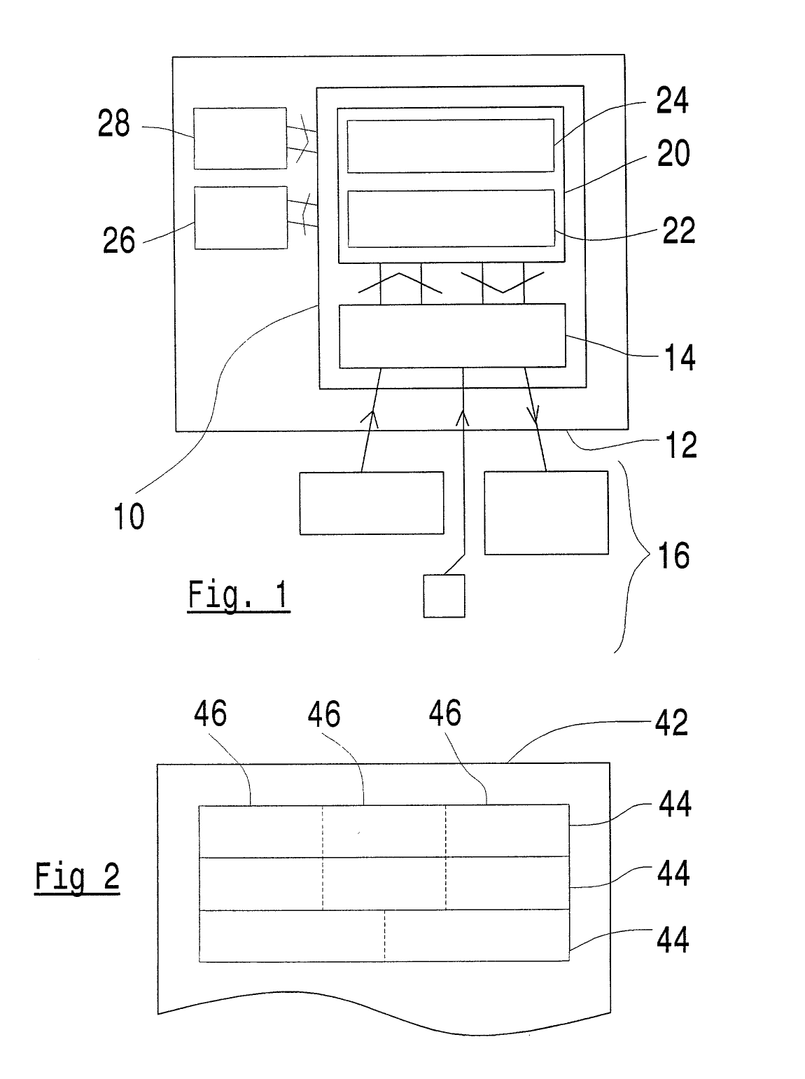

This embodiment, illustrated diagrammatically in FIG. 1, is implemented in computer software 10 executing on suitable computer hardware 12. The software includes a user interface 14 operative to cause the computer hardware 12 to interact with a user. By means of the user interface, a user can input deal factors regarding a specific transaction. The user interface 14 can also convey to a user data relating to the deal to be offered to the client, by way of input and output devices 16 connected to the computer hardware 12 (typically over a network). The user interface 14 is not of prime importance to this invention and will therefore not be described in further detail. The computer software 10 further includes a calculation engine 20. The calculation engine 20 operates on data input by a user to generate transaction data that will be displayed back to the user.

The calculation engine 20 includes a quote server 22, which is operative to calculate a price quotation for a proposed transaction entered by a user. The quote server bases its calculations on a margin that it requests from a margin server 24. The margin server 24 is operative to calculate a margin to be applied to the transaction. The software 10 also includes a logging server 26, operative to log details of events that relate to the quote server 22 and the margin server 24, and an administration tool 28, operable by a suitably-authorised user to control various aspects of the operation of the software.

It should be noted that the various components of the software 10 need not operate on a single computer. Instead, they may operate on various computers interconnected in a network, optionally arranged in a client/server configuration.

Overview of Margin Tables

The margin server 24 operates by comparing deal factors of a proposed transaction with deal factor ranges stored in a plurality of tables contained in memory of the computer hardware 12. In FIG. 2, a portion of the memory of the computer hardware 12 is shown diagrammatically at 42. The memory 42 contains an ordered list of at least one margin tier 44. Each margin tier 44 contains an ordered list of one or more margin tables 46. Each margin table 46 contains a plurality of table rows. Each row sets forth one or more deal factors that can be compared with the factors of a proposed transaction, and one or more associated margin values. Within each table 46, each row specifies a similar number of factors; however the number of factors per row may vary from one table to another.

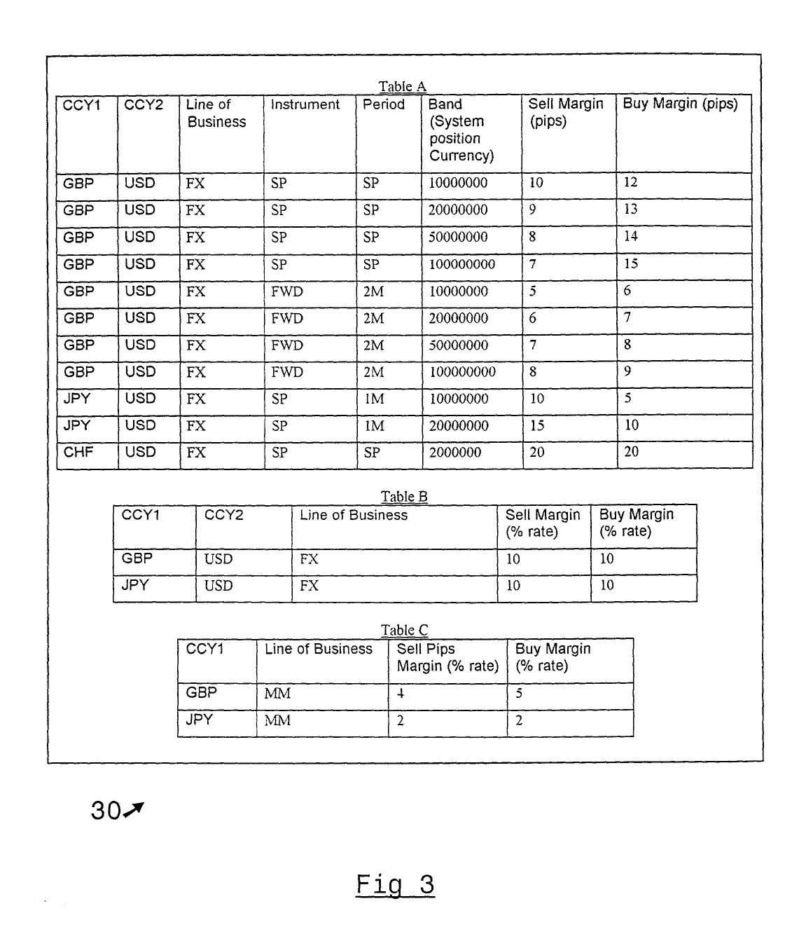

With reference now to FIG. 3, an example margin tier 30 is shown. This example tier contains a list of three margin tables, Table A, Table B and Table C. Table A, the first to be searched, defines margins specified by six deal factors: CCY1 (the first currency involved in a transaction), CCY2 (the second currency involved in a transaction), Line of Business (FX or MM), Instrument (spot rate or forward rate), Period (the time period for a deal) and Band (the upper value limit for the deal). Table B specifies just three deal factors: CCY1, CCY2 and Line of Business. Table C specifies just CCY1 and Line of Business. For all tables, each row specifies a buy margin and a sell margin.

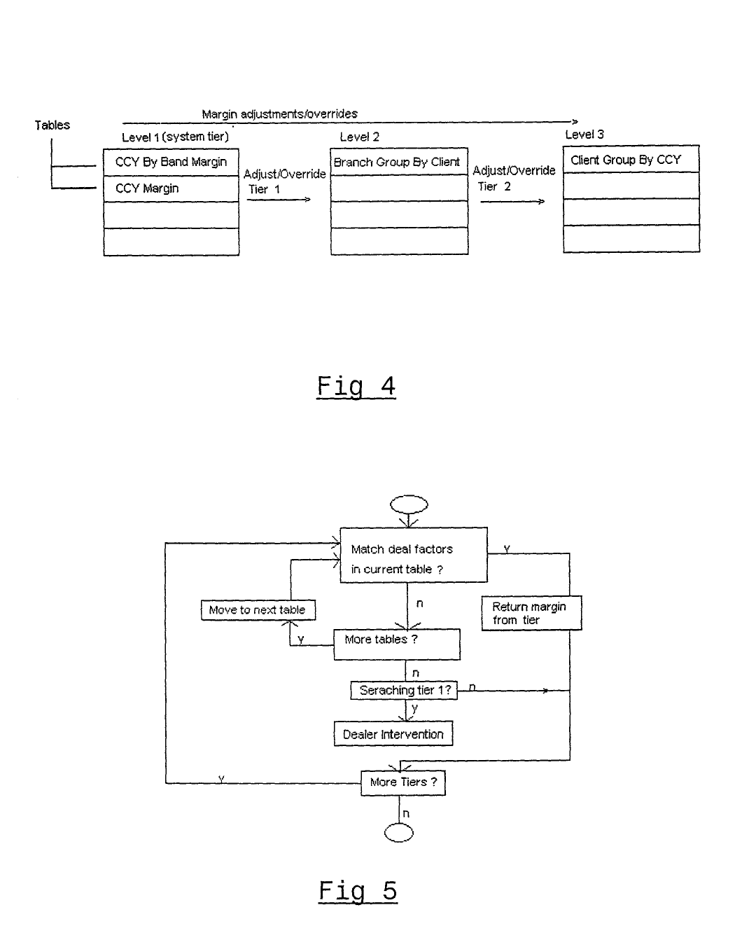

The overall client rate, as calculated by the quote server 22, is made up of the market rate plus the margin adjustments/overrides derived from each of the defined tiers, and possibly from other factors. As a minimum, there is only one tier defined, this tier being known as the system tier. The system tier is always at level one; that is to say, it is the first tier that is considered by the margin server 24. An administrator of the system may use the administration tool 28 to add further tiers up to a predetermined maximum. In this example, up to two further tiers may be added, giving a maximum of three tiers. This multiple-tiered arrangement is shown diagrammatically in FIG. 4. The tiers are labeled Level 1, Level 2 and Level 3, with Level 1 being called the system tier.

The first tier to be applied is the system tier. From that tier, a basic margin is derived. If no match is found for a proposed deal in the system table, it cannot be processed by the system. Once a match is found in the system tier, the Level 2 tier is searched. If a match for the transaction is found, it is added to or overrides the margin derived from the system tier. The process is repeated for Level 3 tier. If no match for a particular transaction is found in the Level 2 and Level 3 tiers, the transaction can be processed by the system. However, no adjustment to the margin is applied by a tier if no match is found.

Search Algorithms

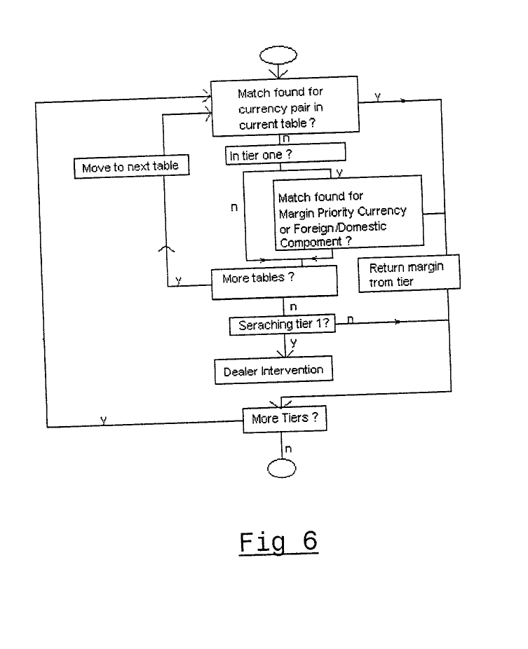

When a user enters a request for a deal on a live system embodying the invention, the margin server 24 may proceed to execute a search algorithm, a flow diagram of which is shown in FIG. 5. This search algorithm, referred to as the “simple search algorithm” selects the system tier and scans each table within it to determine whether a table entry matches the proposed deal factors. If a match is found then the entry's margin is applied to the market rate and the next tier is searched. The final client rate is a combination of the margin from the system tier and adjustments/overrides from subsequent tiers. If, whilst searching the system tier, no match is found against the deal factors supplied then the search is aborted. Further processing of the proposed deal must be carried out manually.

A match is deemed to have been found if all of the factors specified in a line of a table match the factors of the proposed transaction. Thus, a table with a large number of factors defines a transaction with a greater degree of specificity than does a table with a lesser number of factors. For this reason, the tables in a tier are normally arranged, in the order in with a decreasing number of deal factors. In this way, special cases, with a specific combination of a large number of deal factors are tested for first.

As a specific example, consider the following hypothetical table line:

TABLE 1

| CCY | Line of Business | Sell Margin (pips) | Buy Margin (pips) |
|---|---|---|---|
| USD | FX | 10 | 10 |

This will match all FX deals involving US dollars, with the consequence that no subsequent line in a tier will be searched for US dollar FX transactions. This may be used towards the end of the search order of a tier to generate a default margin for such transactions in the event that a transaction does not match any specific conditions set forth in preceding table lines within the tier.

The simple search algorithm is used for all MM transactions, and can also be used for FX transactions. In the later case, an alternative algorithm, referred to as the “rigorous search algorithm” can be used where it is desired that cross rates should be searched in addition to prime rates. Generally, foreign exchange prices are traded through USD and these are called prime rates. For example, a request for CHF/USD would be considered to be a prime rate. However, if a price is requested that not a prime it is deemed to be a cross rate. For example, a request for CHF/JPY would be considered to be a cross rate. What this means is that the CHF/JPY price is derived from CHF/USD and JPY/USD. These prices are crossed to obtain the CHF/JPY price. Therefore the CHF/USD and JPY/USD are the cross components of CHF/JPY. The rigorous search algorithm can be used to extract such cross rates from the margin tables. A flow diagram representing the rigorous search algorithm is shown in FIG. 6.

When a table in the system tier is configured to use rigorous searching the search will initially attempt to match against the primary deal factors, in the manner of the simple search. If a match is not found then the system will attempt to use the cross components of the deal to find a margin value. (If the deal is not a cross deal then the system will treat the search as a simple search and proceed as described above.)

In summary, the following rules apply when carrying out a rigorous search on a table:

1. Search the table first for exact match

2. If exact match not found, re-search the same table using whichever of the component currency pairs has the highest currency margin priority.

3. If margin priorities of the currencies are equal, then search same table using the foreign/domestic cross pair component. (Which of these currencies is chosen is configurable in the system.)

Rigorous searching will only be applied where all of the following conditions apply:

1. The table belongs to the system tier.

2. The currency pair of the deal is a cross currency.

3. The table specifies CCY1 and CCY2 as deal factors.

Margin Priorities

Special consideration must be given to matching a deal when a cross-pair is involved. If no match is found for the cross-pair then a decision must be made as to whether the system should abandon the search or try to match one of the components of the cross. If it is decided to try to match one of the components of the cross, then the system must decide which component is to be used. The system could use the foreign component of the cross, but this will not always lead to a valid result. To ensure that the component is derived from the correct currency pair, each configured currency on the matrix platform is assigned a priority that is used to choose the “correct” component. For example, the Table 2 below shows possible priority settings for GBP, IEP and CHF.

TABLE 2

| Currency | Priority |
|---|---|
| GBP | 100 |
| CHF | 500 |
| IEP | 200 |

In general, the component with the higher priority is chosen for use. With reference to this table, if the cross-pair were, for example, GBP/CHF then the CHF component would be used as the match criterion because it has greater priority. This functionality provides the option to configure a currency to never try to apply a margin when crossed against another currency, or to always try to a apply margin when crossed against another currency.

Wildcards

In order to implement “catch all” situations and to reduce the amount of maintenance required to keep the margin tables up-to-date, the system allows one or more deal factors to be specified with wildcard values.

For example, a margin table may include a line that includes a currency specified with a wildcard, as follows:

TABLE 3

| Currency | Amount Margin |
|---|---|
| ***/USD | $10 |

The effect of this table entry means that for all currencies against the dollar apply a margin of $10 (unless a deal has been matched against an earlier entry in the tier).

In this embodiment, the following rules apply when matching wildcards:

1. Currency pairs are reversible: A/B=B/A. For example, USD/GBP=GBP/USD.

2. A match is made on a first found basis. For example, if the requested pair is GBP/USD given Table 4 below the margin applied is $10. Even if the requested pair is USD/GBP the margin is still $10 by application of Rule 1, above. If the administrator wishes, for example, to apply a margin of $15 in particular cases, then a specific currency pair entry should be included in a higher priority table within the same tier.

TABLE 4

| Currency | Amount Margin |
|---|---|
| GBP/*** | $10 |
| USD/*** | $15 |

3. Wildcards are not limited to currency pairs. The lines shown in Table 5 may be included to apply this margin for all currency transactions.

TABLE 5

| Currency | Pips Margin |
|---|---|
| *** | 10 |

The instrument factor may also be specified in a table by means of wildcards, as shown, by way of example, in Table 6 below.

TABLE 6

| Currency | Instrument | Pip Margin |
|---|---|---|
| GBP/USD | SW | 15 |
| GBP/USD | *** | 10 |

The above table directs the system to apply a 15-pip margin to all cable swap deals and to apply a 10 pips margin to all other instruments.

Band Amounts

Margins can be applied to a deal depending on the amount of a currency involved. A match for a band amount factor is found if the deal amount is less than or equal to the band amount in the table.

Table 7 below is presented by way of an example of application of a band factor. Assuming USD is the system position currency, if a 0.5 Million USD/GBP deal is requested then the deal is matched by the first table entry. However, if the USD/GBP deal is for 4 million, the deal is matched by the second table entry. Any amount greater than 10 Million will not result in a match.

TABLE 7

| | | Band (system position | | |
|---|---|---|---|---|
| CCY1 | CCY2 | currency) | Sell Margin | Buy Margin |
| GBP | USD | 1 Million | 10 | 10 |
| GBP | USD | 10 Million | 15 | 15 |

In embodiments in which wildcards are not supported for band amounts, it may be necessary to configure a band for a very large sum in order to catch proposed deals that are of a very high value. An example of this is shown in Table 8. Alternatively a separate table with no band information can be specified, an example being presented in Table 9. Lines in such a table can be matched by a proposed deal, irrespective of its value.

TABLE 8

| CCY1 | CCY2 | Band | Sell Margin | Buy Margin |
|---|---|---|---|---|
| GBP | USD | 1 Million | 10 | 10 |
| GBP | USD | 10 Million | 15 | 15 |
| GBP | USD | 1000000 Million | 50 | 50 |

TABLE 9

| CCY1 | CCY2 | Sell Margin | Buy Margin |
|---|---|---|---|
| GBP | USD | 50 | 50 |

Tier Management

By default, the system will have one tier; the system tier, as defined above. The administrator can use the administration tool 28 to add further tiers, to a maximum total of three tiers, in this embodiment. No changes made to the margin configuration will take effect until the administrator saves the changes. Changes requested may take a period of time before affecting incoming requests and will not effect any margin information that has been supplied by the margin server 24 previous to the saved changes. When a tier is added, the administrator will be asked by the administration tool 28 to provide a unique name to be assigned to the tier and to define whether the tier is active or not.

The administrator will also have the ability to delete a tier. All tables within that tier will be lost once deleted. However, the system tier cannot be deleted.

Table Management

By means of the administrative tool 28, the administrator may add margin tables to any tier. Before a table is created the administration tool 28 will require the administrator to enter the following information into the system:

TABLE 10

| Detail | Description |
|---|---|
| Table Name | Name for the table which should be unique within |
| | the tier |
| Factors | One or more deal factors: |
| | CCY1 |
| | CCY2 |
| | Band |
| | Instrument |
| | Period |
| | Trading Client |
| | Trading Client Group |
| | Line of Business |
| | Branch |
| | Branch Group |
| Margin Effect | Specifies if margins are an adjustment or an override |
| Margin Weighting | Specifies if the margin is to be skewed |
| Search Algorithm | Simple or Rigorous (defaults to Simple) |

In cases where the margin weighting is skewed, a table will be created with two margin columns (buy and sell) otherwise a single margin column is used. The table will also include the deal factors chosen by the administrator. The new table is appended to the end of the list of tables within a given tier. That is, it will, by default, be assigned the lowest priority for the purpose of searching. Moreover, the table will initially be disabled; that is to say, it will not be included in searches. The administrator may use the administrative tool 28 to change the priority of a table as required. Each table entry within a margin table can specify its own margin type

A table with no entries has no effect on the system. All entries must supply valid values for all deal factors. Therefore, where a deal factor is specified its value cannot be left blank.

The administrative tool 28 can be used to delete a table from a given tier. All table information will be permanently lost.

The administrator may use the administrative tool 28 to change data in the table in various ways.

The administrator may change any value in a given table by selecting the relevant cell and changing the value.

Deal factors can be inserted into an existing margin table from the list of supported deal factors. No factors may be repeated within the same table. By default, new factors are appended to the end of the deal factors list.

The administrator can delete a factor from an existing table. All information within the factor column is lost. The administrative tool 28 will automatically detect and handle duplicate table entries that might result from a delete operation.

The administrative tool 28 permits the administrator to add a new entry to an existing table. All entries must contain valid data; no entry may be left blank.

The administrator can likewise delete an existing table entry.

The administrator can move a table entry up or down within a table. As tables are searched in order this operation has the effect of increasing or decreasing the priority of an entry within a given table for searching purposes.

Table priority within a given tier can be increased/decreased by the administrator.

In a system operable to calculate margins for both MM and FX transactions, two separate sets of tables may be stored in memory 22, one set for each type of transaction. Alternatively, there may be just one set of tables, with each table row having an indication as to the type of transaction to which it relates.

Changing Margin Effect—Adjustment Versus Override

Margins retrieved from a tier (other than the system tier) can be either added to the previously calculated current client rate or can override a previously calculated margin. The administrator may specify on a per table basis whether the margin is to be an adjustment to the current client rate or to be an override, this choice being stored as a flag in the table's data. (Note that the flag is not a deal factor, therefore it does not influence the result of a search.)

Table 11 below compares the effects of this option. With reference to Table 11, the left column of the table shows the pips margin of tier 2 being applied to a current client rate. The right column shows the current client rate being discarded and the pips margin being applied to the initial market rate.

TABLE 11

| Adjustment | | Override | |
|---|---|---|---|
| Initial Market Rate + | 1.5050/60 | Initial Market Rate + | 1.5050/60 |
| Level 1 Pips Margin = | 10/10 | Level 1 Pips Margin = | 10/10 |
| Current Client Rate | 1.5040/70 | Current Client Rate | 1.5040/70 |
| adjust current margin | | override current margin | |
| Level 2 Pips Margin = | 10/10 | Level 2 Pips Margin = | 10/10 |
| New Client Rate | 1.5030/80 | New Client Rate | 1.5040/70 |

Tables can be enabled or disabled. This has the effect of either adding or removing the table from a search respectively. Newly created tables are deactivated by default.

Changing Table Priorities

By default a currency is assigned a margin priority of 500. The highest margin priority is 999 and the lowest is 0. The administrative tool 28 may be used to alter all configured currencies margin priority.

Security

Administrators of the system must be authorised to enter and amend margin tables. Depending on their level of authorisation, administrators will be assigned a feature set that is available within the administrative tool 28. Table 12 illustrates levels of authorisation available in this embodiment:

TABLE 12

| Level | Authorisation type | Description |
|---|---|---|
| 1 | View Margin Table | Allows administrator read only access to the |
| | | view existing margin tables |
| 2 | Modify Margin Data | Allows administrator to modify margin data |
| 3 | Modify Margin | Allows administrator to create, delete and |
| | Table/Tiers | modify tables and tiers. |

Each level of authorisation inherits administrative rights from lower authorisation levels. For example, an administrator with level 3 authorisation automatically inherits level 1 and level 2 authorisation.

Note: The method for the allocation of user privileges is outside the scope of this application and will therefore not be dealt with here.

External interaction

The margin editor and runtime margin engine is expected to interact with the following modules:

1. Logging Server: (this is described below)

2. Quote Server: the quote server will use the margin calculations engine to apply margining to market rates.

3. Third-party applications.

1. Payment Services.

5. Application program interface.

Logging

It is useful for an administrator to be able to review the mechanism by which a client rate was derived by the system. To this end, the system includes a logging server that logs details of each margin calculated across the available tiers. The log will show the following information:

1. System Time stamp

2. Requested deal factors

3. Per tier margin application details

If any configuration data in the margin database is changed by the administrative tool 28, this event is also logged so that the change can be audited at a later date. It is expected that in many practical embodiments, the following details will be appended to the system log.

1. Time Stamp: the time when the action was attempted

2. User: the identity of the user attempting the operation

3. Authorisation Level: the administrative privilege level of the user

4. Operation attempted: details of what was attempted by the user

Operations that fail due to authorisation failure will also be logged.

Rounding

When calculating the client rate, the calculation engine 20 will only apply rounding when all tiers have been processed. When dealing with the market rate full precision will be used if configured. Where client rates must be rounded, either standard rounding rules or non-mathematical rounding rules will be applied. The non-mathematical rounding rules rounds in favour of the bank if required to ensure that the bank always sends out the most profitable rate to the client.

Margin Types

The available margin types and illustrative examples of their application will now be described in further detail. In the examples that follow, the following abbreviations will be used:

| | | |
|---|---|---|
| MR | = | Market Rate |
| RP | = | Rate Percentage |
| CCR | = | Current Client Rate |
| PM | = | Pips Margin |
| MP | = | Margin Percentage |

FX margins are specified in one of four methods:

1. Rate Percentage

2. Margin Percentage

3. Pips

4. Profit Amount

MM margins are specified in one of two methods:

1. Fraction/Decimal: values are specified as units of a rate, which are added/subtracted to the market rate.

2. Profit Amount

Any single margin table may have a mixture of margin types. The various margin types will now be described in more detail

Rate Percentage: The margin is expressed as a percentage of the market rate and is only applied in the system tier. For example given the following cable rate GBP/USD (1.6050/6060) and a rate percentage margin of 10/10 for sell and buy rates respectively, the client rate would be as follows:

Client Rate=(MR*(100+/−RP))/100

Bank Sells

Client Rate=(1.6050*90%)=1.4445

Bank Buys

Client Rate=1.6060*110%=1.7666

So the client rate would be 1.4445-1.7666

Margin Percentage: When applied to a table, the margin for the tier containing the table is expressed as a percentage of the cumulative margins from the previous tiers. Margin percentages cannot be applied in the system tier and cannot be used for tables with a margin effect of override, as described above.

For example:

| | |
|---|---|
| Market | GBP/USD 1.6050/6060 |
| Rate | |
| Current | GBP/USD 1.4445/1.7666 |
| Client | |
| Rate | |
| Margin | 10/10 |
| Percentage | |
| The new | Client Rate = MR +/− (((CCR − MR) * MP)/100) |
| client rate | |
| is: | |
| Bank Sells | (1.6050 − 1.4445) * 10% = 0.01605 => 1.6050 − 0.01605 = |
| 1.5889 | |
| Bank | (1.7666 − 1.6060) * 10% = 0.01606 => 1.6060 + 0.01606 = |
| Buys | |
| 1.6221 | |
| | Client Rate = 1.5890/1.6221 |

Pips Margin: A pip is defined as the smallest unit of difference between two rates where the rate has a fixed number of decimal places. For example:

GBP/USD is quoted to four decimal places therefore each pip has a value of 1/10000 or 0.0001

JPY/USD is quoted to two decimal places therefore each pip has a value of 1/100 or 0.01

Client Rate=CCR+/−PM

Pips margins are a straight application of the sell/buy margin to the sell and buy sides of a rate. Pips margins may be applied on all tiers.

| | |
|---|---|
| Market Rate: | GBP/USD 1.6050/6060 |
| Pips Margin: | 10 pips (= 0.0010) |
| Bank Sells | Subtract pips from the sell rate |
| | Client Rate = 1.6050 − 0.0010 = 1.6040 |
| Bank Buys | Add pips to buy rate |
| | Client Rate = 1.6060 + 0.0010 = 1.6070 |
| | Client Rate = 1.6040/70 |

Profit Amount Margin: Profit amount margins may be applied to all tiers. In this case, the margin is specified as currency amount, which is converted to pips and applied to the market or current client rate depending on the tier in which the amount margin is found. The following scenarios are possible

Bank Sells

1. Direct rate where fixed amount is specified in the base currency

2. Direct rate where fixed amount is specified in the non-base currency

3. Indirect rate where fixed amount is specified in the base currency

4. Indirect rate where fixed amount is specified in the non-base currency

Bank Buys

5. Direct rate where fixed amount is specified in the base currency

6. Direct rate where fixed amount is specified in the non-base currency

7. Indirect rate where fixed amount is specified in the base currency

8. Indirect rate where fixed amount is specified in the non-base currency

Where a margin needs to be converted to the counter currency amount the following rules apply when choosing the sign of a rate to use in the conversion.

TABLE 13

| Bank | Quote (Deal) | Counter Currency Rate Used in conversion |
|---|---|---|
| Sells | Direct | Sell |
| Buys | Direct | Buy |
| Sells | Indirect | Buy |
| Buys | Indirect | Sell |

The conclusion is that the only parameter which effects the margin application is whether the Bank is selling the fixed currency or buying the fixed currency, as shown in Table 14.

TABLE 14

| Fixed | Margin Application to counter amount |
|---|---|
| Bank Sells | Added |
| Bank Buys | Subtracted |

Guaranteed Profit

In preferred embodiments, a table may be configured to specify a minimum profit to be made on a deal. A simplified example of such a table is shown below as Table 15.

TABLE 15

| | | | Sell Margin | Buy Margin |
|---|---|---|---|---|
| Currency 1 | Currency 2 | LOB | (profit amount) | (profit amount) |
| GBP | USD | FX | 500 | 500 |
| JPY | USD | FX | 1000 | 1000 |
| CHF | USD | FX | 300 | 300 |
| GBP | CHF | FX | 100 | 150 |

In this table, Sell Margin specifies the guaranteed profit on the sell side of the rate and Buy Margin specifies the guaranteed profit on the buy side of the rate.

In the following formulae, the following symbols will be used:

Client Rate=A

Market Rate=B

Fixed Amount=C

Market Counter Amount=D

Client Counter Amount=E

Fixed Profit Amount=F

Fixed Profit Counter Amount=G

In order to calculate the client rate that will achieve the profit required, the system carries out the following calculation steps:

Step 1. D=(C/B): Calculate the trade counter amount using the market rate. This could also be (C*B) depending on the quote basis.

Step 2. G=(F/B): Calculate the profit counter amount using the market rate. The profit amount “F” must be in the same currency as the fixed amount.

Step 3. E=(D+/−G): Calculate the client counter amount. This assumes the margin is “G”. The “+” or “−” depends on whether the transaction is a buy or a sell.

Step 4. A=(C/E): Calculate the new client rate from the two counter amounts. This could also be E/C depending on the quote basis.

While this aspect of the invention has been described with reference to foreign exchange transactions, this aspect can also be applied to money market transactions.

Margin Instrument Support

The following are the instruments supported by this embodiment:

FX Instruments

1. Spot

2. Forward

3. Forward Option

4. Swap

MM Instruments

1. Deposit

2. Loans

3. Rollovers

4. Extensions

5. Takeups

For the spot instrument a single margin is retrieved. To produce the client rate the margin is applied to the spot rate, as follows:

Client rate=Spot rate+Spot Margin

For example:

TABLE 16

| | |
|---|---|
| GBP/USD Market Rate | 1.5660/70 |
| Instrument | Spot |
| Margin | 10 pips |
| Client Rate | 1.5560/80 |

Forward (FW): with a forward instrument there are two margins to retrieve i.e. the spot rate margin and the forward rate margin. The spot rate is only applied on the system tier. Subsequent tiers only apply the forward rate margin. The system can be configured to ignore the spot rate margin. When dealing with cross pairs optimising only occurs on the cross and not on the components of that cross. If rigorous searching is employed to obtain the spot margin then the same currency pair must be used for the forward component, otherwise the search will fail.

Client Rate=(Spot Rate+/−Spot Margin)+/−(Forward points+/−Forward Margin)

The sign of each of the terms of this formula is dependent upon whether the forward points are at a premium or at a discount. For example:

TABLE 17

| | |
|---|---|
| GBP/USD Spot | 1.5660/70 |
| Instrument | Forward |
| 1M forward Points | 5 |
| Forward Points Margin | 2 |
| Spot Margin | 10 pips |
| Client Rate | 1.553/87 |

Forward Option (FO): Forward Options are treated the same as Forwards except that the deal has two dates an option date and a value date. The spot margin is applied to the spot component. The forward margin is retrieved for the best rate (pricing) date within the option period and is applied to the forward points.

Swaps (SW), Early Take-up (TU), Extensions (EX): With a swap the margin is retrieved using the far date. The margin is always applied to the swap points.

Margin Deal Periods

Deal periods in this embodiment are as follows:

TABLE 18

| | |
|---|---|
| ON | Over Night |
| TN | Tomorrow Next |
| SP | Spot |
| SN | Spot Next |
| +2 | 2 days after spot |
| +3 | 3 days after spot |
| +4 | 4 days after spot |
| +5 | 5 days after spot |
| 1W-3W | 1 week-3 Week |
| 1M-11M | 1 Month-11 Months |
| 18M | 18 Months |
| 1Y-10Y | 1 Year-10 Years |

Deals falling between defined periods (i.e. “broken dates”) will be matched with the nearest period greater than the specified period. For example if a client wishes to sell $1 M USD buy GBP Spot against 6 weeks then the matching period for this deal will be 2 M. Table 19 below shows which leg of a deal is used when comparing deal periods:

TABLE 19

| | |
|---|---|
| Instrument | Date used |
| Spot | Spot date |
| Forward | value date |
| Forward Option | Best pricing date of option period |
| Swap | Far date |
| Deposit | Maturity date |
| Loan | Maturity date |
| Roll-over | Maturity date |

Margin Examples

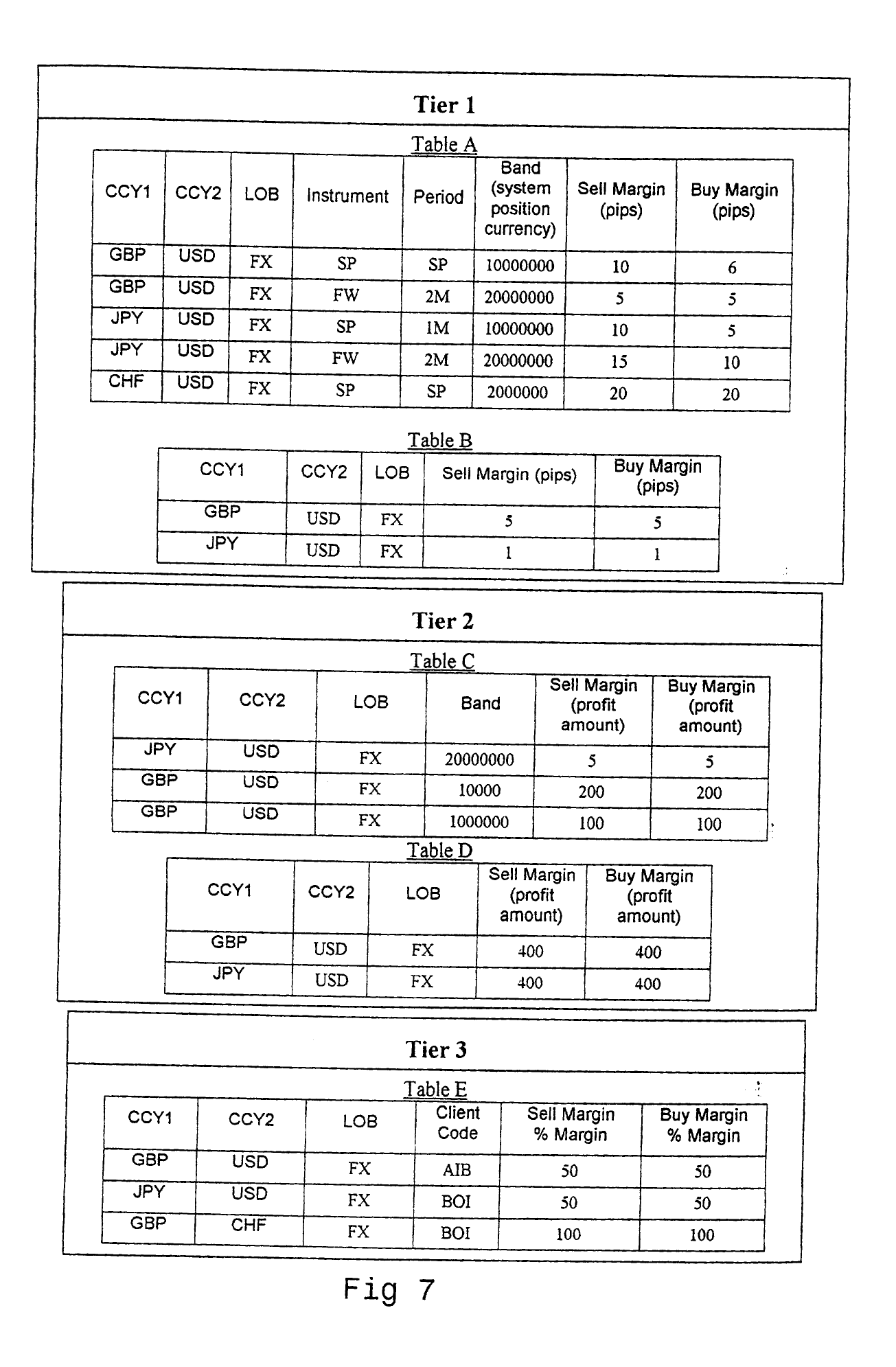

This section gives some test data and some fictitious deals to further illustrate how the system arrives at an overall margin. The margin tables used in these examples are presented in FIG. 7.

Case 1: Client Sells GBP spot against USD

TABLE 20

| Client | AIB |
|---|---|
| GBP/USD | 1.6050/60 |
| Instrument | Spot |
| Amount | £1 Million |
| CCY1 | GBP |
| CCY2 | USD |
| Period | Spot |
| Table A, B, C, D, E | Margin type Adjustment |
| Table A, B, C, D, E | Use simple search |

Tier 1 Searched

1. Table entry A:1 yields the pips spot margin of 10

2. Client Sell Rate after tier 1=1.6040

Tier 2 Searched

1. Table Entry C:3 yields an amount margin of $100.

Counter Amount−Amount Margin=$1603900

Client Sell Rate after tier 2=1.6039

Tier 3 Searched

2. Table entry E:1 yields a percentage margin of 50% for sell rate.

Client Rate after tier 3=1.6050−((1.6050−1.6039)*50%)=1.6044

Final Client Sell Rate 1.6044

Case 2: Client Sells GBP spot against CHF

TABLE 21

| Client | BOI |
|---|---|
| GBP/CHF | 2.0050/60 |
| Instrument | Spot |
| Amount | £1 Million |
| CCY1 | GBP |
| CCY2 | CHF |
| Period | Spot |
| Table A, B, C, D, E | Margin type Adjustment |
| Table A, B, C, D, E | Use simple search |

Tier 1 Searched

1. Table A searched and no match found for GBP/CHF

2. Table B searched and no match found for GBP/CHF

3. Table C searched and no match found for GBP/CHF

No match found in the system tier so the search is abandoned and the deal is sent for dealer intervention.

Case 3: Client Sells GBP against CHF 6 weeks forward outright

TABLE 22

| Client | BOI |
|---|---|
| GBP/CHF | 1.6050/60 |
| Instrument | Forward |
| Amount | £1 Million |
| CCY1 | GBP |
| CCY2 | USD |
| Period | 6 Weeks |
| Forward Points | 10 |
| Table A, B, C, D, E | Margin type adjustment |
| Table A, B, C, D, E | Use simple search |

Tier 1 Searched

1. Table A searched for instrument and period of spot

2. Table entry A:1 yields a spot margin of 10 pips

Client sell spot rate=Market spot rate−spot margin=1.6050−10=1.6040

1. Table A searched for forward margin

2. Table entry A:2 yields a forward points margin of 5 pips (nearest period greater is 2 M)

Outright client forward sell rate after tier 1=1.6040−5=1.6035

Tier 2 Searched

1. Table Entry C:3 yields an amount margin of $100.

Counter Amount−Amount Margin=$1603400

Client Sell Rate after tier 2=1.6034

Tier 3 Searched

Yields no margin

Final Client Sell Rate=1.6034

Case 4: Client Sells GBP against USD swap

TABLE 23

| Client | BOI |
|---|---|
| GBP/USD | 1.6050/60 |
| Instrument | Forward |
| Amount | £1 Million |
| CCY1 | GBP |
| CCY2 | USD |
| Period | 6 Weeks |
| Forward Points | 10 |
| Table A, B, D, E | Margin type Adjustment |
| Table C | Margin type Override |
| Table A, B, C, D, E | Use simple search |

Tier 1 Searched

1. Table A searched for instrument and period of spot

2. Table entry A:1 yields a spot margin of 10 pips

Client sell spot rate=Market spot rate−spot margin=1.6050−10=1.6040

1. Table A searched for forward margin

2. Table entry A:2 yields a forward points margin of 5 pips (nearest period greater is 2 M)

Outright client forward sell rate after tier 1=1.6040−5=1.6035

Tier 2 Searched

1. Table Entry C:3 yields an amount margin of $100.

Adjustment is override so work off the market rate

Counter Amount−Amount Margin=$1605000−$100=1604900

Client Sell Rate after tier 2=1.6049

Tier 3 searched

Yields no margin

Final Client Sell Rate=1.6049

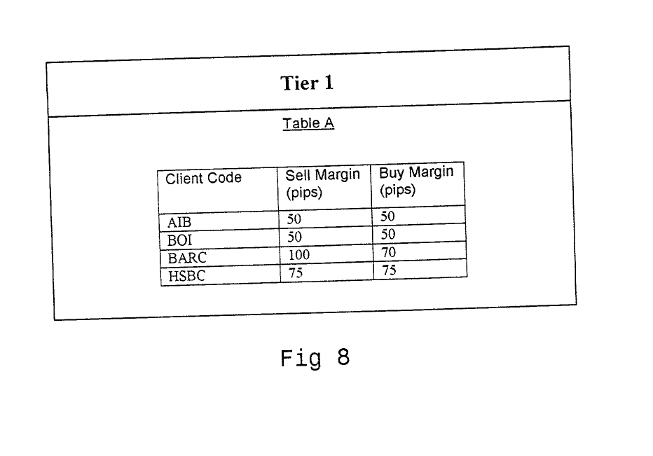

The above examples have shown currency based pricing. The next example shows how the system can be used to give client specific pricing. This example refers to margin tables shown in FIG. 8.

Case 5: Client Sells GBP spot against USD

TABLE 24

| Client | BARC |
|---|---|
| GBP/USD | 1.6050/60 |
| Instrument | Spot |
| Amount | £1 Million |
| CCY1 | GBP |
| CCY2 | USD |
| Period | Spot |
| Table A | Margin Type Adjustment |

Tier 1 Searched

1. Table A searched

2. Table A yields a sell pips margin of 50.

Tier 2 not configured

Tier 3 not configured

Final Client Sell Rate=1.6000

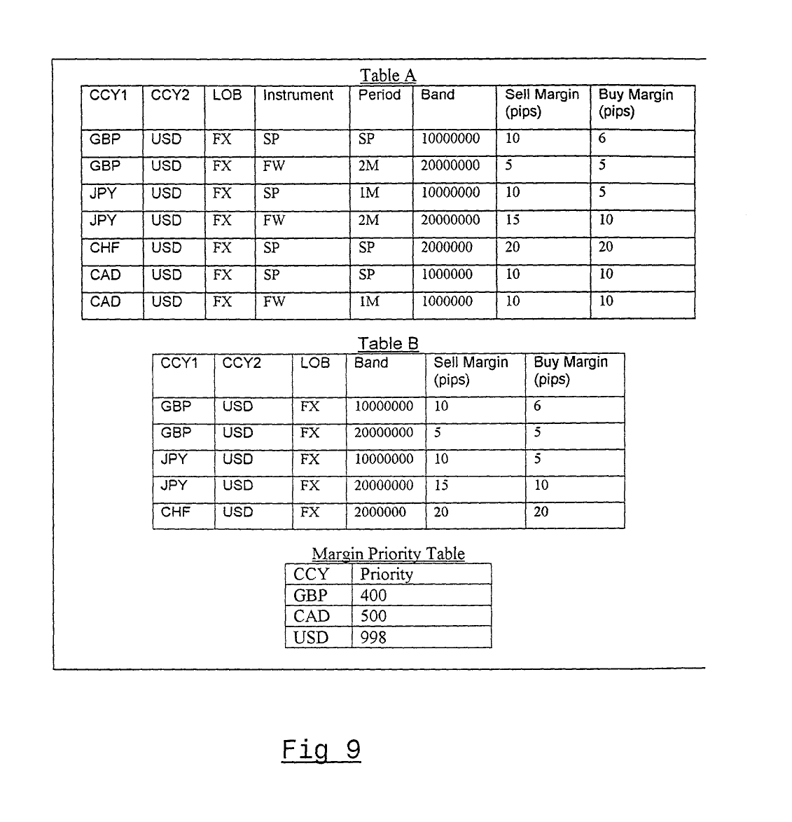

The final example, to be described below, illustrates use of the rigorous search algorithm previously described. This example will refer to the margin tables shown in FIG. 9.

Case 6: The following trade is requested:

TABLE 25

| Currency pair | GBP/CAD |
|---|---|
| Market Rate | 1.5050/60 (CAD/USD) |
| Product | Spot |
| Amount | Bank Sells $5m(position amount) |
| Period | Spot |
| Table A | Use Rigorous Search |
| Table B | Use Simple search |

Tier 1

1. Look for exact match of GBP/CAD in table A

2. Not found so get margin priority of the cross components and select highest priority currency

3. CAD has highest margin priority and is selected.

4. System now searches table A for currency pair CAD/USD

Table entry A:6 yields a pip margin of 10

Tier 1 search completed

Tier 2 not configured

Tier 3 not configured

Final Client Rate 1.5040/70 (used to cross with GBP/USD to give client rate)

Examples of Guaranteed Profit Transactions

Several examples of guaranteed profit transactions will now be described by way of example. These examples apply the calculation formulae described above. In these examples, the terms “direct” and “indirect” are used to denote if the counter amounts are multiplied or divided by the market rate. All examples assume an amount margin of $10 for both buy and sell.

### EXAMPLE 1

### Direct Rate Where Fixed Amount is Specified in the Base Currency

Bank Sells USD $1000

TABLE 26

| | |
|---|---|
| GBP/USD | 1.6050/60 |
| Fixed | $1000 |
| Amount | |

| | | | | |
|---|---|---|---|---|
| Market Counter Amount | = | 1000/1.6050 | = | 623.0529 |
| (GBP) | | | | |
| Converted Profit Margin | = | 10/1.6050 | = | 6.2305 |
| (GBP) | | | | |
| Client Counter Amount (GBP) | = | 623.0529 + 6.2305 | = | 629.2834 |
| Client Rate (s) (USD) | | 1.5891 | | |

Bank Buys USD $1000.

TABLE 27

| | |
|---|---|
| GBP/USD | 1.6050/60 |
| Fixed | $1000 |
| Amount | |

| | | | | |
|---|---|---|---|---|
| Market Counter Amount | = | 1000/1.6060 | = | 622.6650 |
| (GBP) | | | | |
| Converted Profit Margin | = | 10/1.6060 | = | 6.2266 |
| (GBP) | | | | |
| Client Counter Amount (GBP) | = | 622.6650 − 6.2266 | = | 616.4495 |
| Client Rate (b)(USD) | | 1.6222 | | |

### EXAMPLE 2

### Direct Rate Where Fixed Amount is Specified in the Non-base Foreign) Currency.

Bank Sells GBP £1000.

TABLE 28

| | |
|---|---|
| GBP/USD | 1.6050/60 |
| Fixed Amount | £1000 |

| | | |
|---|---|---|
| Market Counter Amount (USD) | = 1000 * 1.6060 | = 1606 |
| Converted Profit Margin (USD) | = 10 | = 10 |
| Client Counter Amount (USD) | = 1606 + 10 | = 1616 |
| Client Rate (b) (GBP) | = 1.6160 | |

Bank Buys GBP £1000.

TABLE 29

| | |
|---|---|
| GBP/USD | 1.6050/60 |
| Fixed Amount | £1000 |

| | | |
|---|---|---|
| Market Counter Amount (USD) | = 1000 * 1.6050 | = 1605 |
| Converted Profit Margin (USD) | = 10 | = 10 |
| Client Counter Amount (USD) | = 1605 − 10 | = 1595 |
| Client Rate (s) (GBP) | = 1.5950 | |

### EXAMPLE 3

### Indirect Rate Where Fixed Amount is Specified in the Base Currency

Bank Sells USD $1000.

TABLE 30

| | |
|---|---|
| USD/CHF | 1.5020/30 |
| Fixed Amount | $1000 |

| | | |
|---|---|---|
| Market Counter Amount (USD) | = 1000 * 1.5030 | = 1503 |
| Converted Profit Margin (USD) | = 10 * 1.5030 | = 15.03 |
| Client Counter Amount (USD) | = 1503 + 15.03 | = 1518.03 |
| Client Rate (b) (CHF) | = 1.5181 | |

Bank Buys USD $1000.

TABLE 31

| | |
|---|---|
| USD/CHF | 1.5020/30 |
| Fixed Amount | $1000 |

| | | |
|---|---|---|
| Market Counter Amount (USD) | = 1000 * 1.5020 | = 1502 |
| Converted Profit Margin (USD) | = 10 * 1.5020 | = 15.02 |
| Client Counter Amount (USD) | = 1502 − 15.02 | = 1486.98 |
| Client Rate (s) (CHF) | = 1.4870 | |

### EXAMPLE 4

### Indirect Rate Where Fixed Amount is Specified in the Foreign Currency

Bank Sells CHF 1000.

TABLE 32

| | |
|---|---|
| USD/CHF | 1.5020/30 |
| Fixed Amount | 1000 |

| | | |
|---|---|---|
| Market Counter Amount (USD) | = 1000/1.5020 | = 665.7790 |
| Converted Profit Margin (USD) | = 10 | = 10 |
| Client Counter Amount (USD) | = 665.7790 + 10 | = 675.7790 |
| Client Rate (s) (CHF) | = 1.4798 | |

Bank Buys CHF 1000.

TABLE 33

| | |
|---|---|
| USD/CHF | 1.5020/30 |
| Fixed Amount | 1000 |

| | | |
|---|---|---|
| Market Counter Amount (USD) | = 1000/1.5030 | = 665.3360 |
| Converted Profit Margin (USD) | = 10 | = 10 |
| Client Counter Amount (USD) | = 665.3360 − 10 | = 655.3360 |
| Client Rate (b) (CHF) | 1.5259 | |

Taking all the cases 1-4 it can be noted that when the bank is selling the fixed amount the margin amount is added and when the bank is buying the fixed amount the margin is subtracted.

TABLE 34

| | Margin Application to |
|---|---|
| Fixed | counter amount |
| Bank Sells | Added |
| Bank Buys | Subtracted |

It should be noted that all of the tables and examples described above are very simplified versions and these would typically be more complex in an automated financial transaction system.

1. A transaction system for automatically determining a margin for a transaction comprising: at least one margin table in which is stored a plurality of deal factors that specify a possible deal and a margin value associated with the factors; a search engine for searching the table for an entry to correspond to a proposed transaction and to calculate a margin value therefrom, wherein the margin table is included in a margin tier, the tier being adapted to contain a plurality of margin tables which can be searched by the search engine in a predetermined order.

2. A transaction system according to claim 1 in which the margin is derived from the first margin table entry in the margin tier that is found by the search engine.

3. A transaction system according to claim 1 in which the margin tables within a tier contains a dissimilar number of deal factors.

4. A transaction system according to claim 3 in which each table within a tier contains a number of deal factors not greater than the number of deal factors contained in any preceding table of the tier.

5. A transaction system according to claim 1 comprising a plurality of margin tiers, each tier containing at least one margin table.

6. A transaction system according to claim 5 in which the search engine searches each tier in turn to attempt to obtain a margin value from each tier.

7. A transaction system according to claim 5 in which the search engine abandons a search in the event that no match for a transaction is found in the first tier.

8. A transaction system according to claim 5 in which a margin value obtained from a tier other than the first tier overrides or adjusts a margin value obtained from a previous tier.

9. A transaction system according to claim 5 in which the search engine operates to ignore any tier, other than the first tier, in the event that no match for a proposed transaction is found in that tier.

10. A transaction system according to claim 1 in which a margin value in a tier is associated with a priority value that indicates which of a plurality of alternative margin values should be selected for a particular transaction.

11. A transaction system according to claim 10 in which the priority value is used to select between a plurality of alternative margin values to be applied to a cross component of a cross deal.

12. A transaction system according to claim 1 further comprising an administration tool by means of which an administrator can add, amend or delete entries from a margin tier, and add, amend or delete a margin tier.

13. A transaction system according to claim 12 in which the administration tool can add amend or delete deal factors from a margin table.

14. A transaction system according to claim 1 in which the transaction is a foreign exchange or a money market transaction.

15. A transaction system according to claim 1 further comprising a quotation server operative to generate a price from a transaction based on a calculated margin value.

16. A transaction system according to claim 1 further comprising a user interface for presenting calculated transaction data to a user.

17. A transaction system, which is operative to calculate a client rate for a deal required to make a specified profit on the deal.

18. A method for automatically determining a margin for a transaction comprising storing in a plurality of margin tables a plurality of deal factors that specify a possible deal and a margin value associated with the factors; searching the margin table for an entry corresponding to a proposed transaction; and calculating a margin value therefrom, wherein the margin tables are stored in a margin tier, and are searched in a predetermined order.

19. A method according to claim 18 further comprising a step of calculating a quote for a deal based on the determined margin value.

20. A method according to claim 18 further comprising steps of obtaining data specifying a proposed deal from a user, and presenting a calculated quotation for a deal to a user.

21. A method according to claim 18 operating a transaction system for automatically determining a margin for a transaction comprising: at least one margin table in which is stored a plurality of deal factors that specify a possible deal and a margin value associated with the factors; a search engine for searching the table for an entry to correspond to a proposed transaction and to calculate a margin value therefrom, wherein the margin table is included in a margin tier, the tier being adapted to contain a plurality of margin tables which can be searched by the search engine in a predetermined order.

22. A method for automatically determining a margin for a transaction which calculates a rate for a deal that is required to yield a specified profit on a deal.

23. A method according to claim 22 in which a margin A to generate a profit F is calculated in the following steps, or mathematical equivalents thereof:
1. D=(C/B)
2. G=(F/B)
3. E=(D+/−G)
4. A=(C/E)
where
B=Market Rate;
C=Fixed Amount of the transaction;
D=Market Counter Amount;
E=Client Counter Amount; and
G=Fixed Profit Counter Amount.

24. A method according to claim 22 in which a margin A to generate a profit F is calculated in the following steps, or mathematical equivalents thereof:
1. D=(C*B)
2. G=(F/B)
3. E=(D+/−G)
4. A=(C*E)
where
B=Market Rate;
C=Fixed Amount of the transaction;
D=Market Counter Amount;
E=Client Counter Amount; and
G=Fixed Profit Counter Amount.

25. A method according to claim 18 operative to determine a rate for a foreign exchange transaction.

26. A method according to claim 25 in which the transaction is a cross deal, and a cross component of the transaction is determined by a step that includes comparison of priority values associated with a plurality of rate values, and selecting the rate value that has the higher or highest priority.

27. A method according to claim 18 operative to determine a rate for a money market transaction.
